(19) United States
(12) Patent Application Publication
(10) Pub. No.: US 2019/0102844 A1
(43) Pub. Date: Apr. 4, 2019

(54) CENTRALIZED TAXATION EVALUATION

(71) Applicant: SAP SE, Walldorf (DE)

(72) Inventors: SUMIT DEY, Bangalore (IN); RAJESH SELVANAYAGAM, Bangalore (IN); MOHAMMAD NABEEL SIDDIQUI, Bangalore (IN)

(21) Appl. No.: 15/724,273

(22) Filed: Oct. 4, 2017

(51) Int. Cl. G06Q 40/00; G06Q 40/02; G06Q 10/10

(52) U.S. Cl. CPC G06Q 40/123; G06Q 10/10; G06Q 40/02

(57) ABSTRACT

Various embodiments of systems, computer program products, and methods to provide centralized taxation evaluation are described herein. In an aspect, a request is received to determine taxation information of a user corresponding to a time interval. Baseline data corresponding to the taxation information is automatically obtained from sources associated with the time interval and carried forward taxation information. Further, the taxation information including liability owed by the user and/or refund owed to the user based on the obtained baseline data, carried forward taxation information and corresponding taxation rules is determined. The determined taxation information is provided to the user for taxation evaluation using a monitor widget displayed on a display device of a computing system.

### BACKGROUND

Taxation process is varied considerably across different jurisdictions and time. Each jurisdiction may have legislated into existence its own levying authorities, with distinct rules, regulations, audit departments and enforcement methods. The first step towards taxation process may rely upon self-reporting by each user, for instance, individual, partnership, corporation, or other entity. Self-reporting may include manually reporting sources of funds and providing associated records based on the distinct rules and regulations of the jurisdiction. Hence, the users may have to understand the rules and regulations to abide by taxation requirements.

However, a substantial portion of the population (e.g., users) lacks required expertise to accurately perform taxation duties as the rules and regulations that underlie the taxation system are complex. Also, there can be defaulters who intentionally may use different channels to hide relevant information to save some funds. Hence, such manual taxation systems may create significant difficulties both for the levying authority and the users. Such difficulties, centered upon one of levying authority's important and basic needs, may create an environment of economic uncertainty.

### BRIEF DESCRIPTION OF THE DRAWINGS

The embodiments are illustrated by way of examples and not by way of limitation in the figures of the accompanying drawings in which like references indicate similar elements. The embodiments may be best understood from the following detailed description taken in conjunction with the accompanying drawings.

FIG. 1 is a block diagram of an example computing environment illustrating centralized taxation evaluation, according to one embodiment.

FIG. 2 is a flow diagram illustrating an example process to provide centralized taxation evaluation, according to an embodiment.

FIG. 3 is a block diagram of an example computing environment illustrating registration of a service provider system with a centralized taxation system, according to one embodiment.

FIG. 4 is a block diagram of an example service provider system illustrating processing a request, according to one embodiment.

FIG. 5 shows an example runtime database, according to one embodiment.

FIG. 6 is a block diagram of an example levying authority system illustrating processing of a request, according to one embodiment.

FIG. 7 is a flow diagram illustrating an example process to provide taxation information when baseline data is incomplete, according to an embodiment.

FIG. 8 is a block diagram illustrating an example computer system, according to an embodiment.

### DETAILED DESCRIPTION

Embodiments of techniques to provide centralized taxation evaluation are described herein. In the following description, numerous specific details are set forth to provide a thorough understanding of the embodiments. One skilled in the relevant art will recognize, however, that the embodiments can be practiced without one or more of the specific details, or with other methods, components, materials, etc. In other instance, well-known structures, materials, or operations are not shown or described in detail.

Reference throughout this specification to “one embodiment”, “this embodiment” and similar phrases, means that a particular feature, structure, or characteristic described in connection with the embodiment is included in at least one of the one or more embodiments. Thus, the appearances of these phrases in various places throughout this specification are not necessarily all referring to the same embodiment. Furthermore, the particular features, structures, or characteristics may be combined in any suitable manner in one or more embodiments.

In this document, various methods, processes and procedures are detailed. Although particular steps may be described in a certain sequence, such a sequence may be mainly for convenience and clarity. A particular step may be repeated more than once, may occur before or after other steps (even if those steps are otherwise described in another sequence), and may occur in parallel with other steps. Further, a step may be executed upon executing another step. Such a situation may be specifically pointed out when not clear from the context. A particular step may be omitted. Further, it is to be understood that the various actions (retrieving, determining, generating, receiving, obtaining, analyzing, evaluating and so on) may be performed by a hardware device (e.g., computing system), even if the action may be authorized, initiated or triggered by a user, or even if the hardware device is controlled by a computer program, software, firmware, and the like.

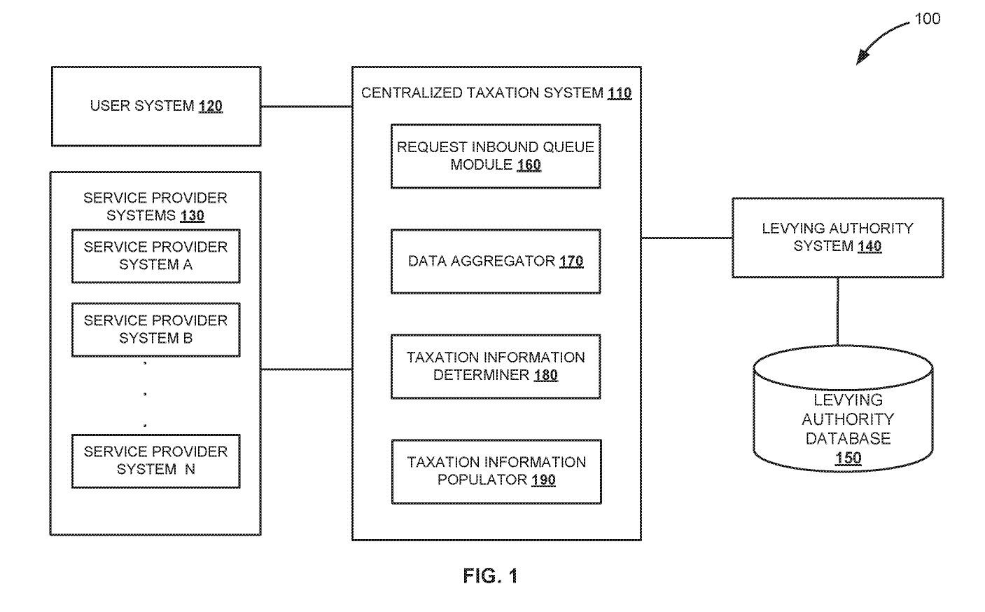

FIG. 1 is a block diagram of example computing environment 100 illustrating centralized taxation evaluation, according to one embodiment. The computing environment 100 may define a set of cooperating computing resources, such as machines (e.g., processor and memory-enabled devices), databases, software libraries, software systems, and the like that form a logical computing infrastructure. Logical computing infrastructure refers to the computing resources that may be geographically distributed across a network, such as the Internet. Also, the techniques presented herein are implemented in the machines, such as processor or processor-enabled devices. These machines are configured to specifically perform the processing of the methods and systems presented herein.

Taxation may refer to obligatory currency or money collection by a levying authority, usually Government of a state or a country. Taxation may apply to different types of involuntary levies, from income to capital gains to estate taxes, for instance. Taxation may be referred to as an act and the resulting revenue may be referred to as taxes. Each jurisdiction (e.g., country and state) may follow distinct laws, rules, regulations, and accounting practices that underlie taxation.

In one embodiment, a central governing mechanism (e.g., centralized taxation system 110) may be interfaced with different components or systems such as, but are not limited to multiple user systems (e.g., user system 120), multiple service provider systems 130 (e.g., service provider A to service provider N) and levying authority system 140 to provide automatic centralized taxation evaluation. Further, the centralized taxation system 110 may reside on Cloud (e.g., third-party server and may require Internmet to access) and/or on-premise (e.g., a dedicated server maintained by an organization).

In one embodiment, users, also referred as taxpayers, may automatically obtain taxation information pertaining to a time interval (e.g., current financial year) via the centralized taxation system 110 without having to be aware of the distinct laws, rules, regulations, and the accounting practices that underlie taxation of a jurisdiction. The taxation information, also referred as financial statement, provides details such as, liability owed by a user and refund owed to the user based on user's baseline data (e.g., different types of income and tax deducted on the income). For example, the user may submit the request to obtain the taxation information associated with the time interval via a web interface application (e.g., a client-server software application in which client (or user interface) runs in a web browser) owned by a levying authority (e.g., Government). The web interface application may be accessed through the user system 120. For example, the user system 120 may belong to the user (e.g., a citizen or a resident), whether individual, partnership, corporation, or other entity. In another example, when the user appoints an assessor or a tax professional to obtain the taxation information, the user system 120 may belong to the tax professional.

In one embodiment, upon receiving the request from the user system 120, the centralized taxation system 110 obtains baseline data from the service provider systems 130 and the levying authority system 140. The baseline data may include financial statements of the user associated with the service provider systems 130 within the time interval. The service provider systems 130 may include different service provider systems (e.g., service provider system A to service provider system B). The service provider systems 130 can be financial institutions providing services as intermediaries of financial markets (e.g., financial communications or transactions such as investments, loans, and deposits). The financial institutions may be, but are not limited to depository institutions (e.g., deposit-taking institutions that accept and manage deposits and make loans, including banks, building societies, credit unions, trust companies, and mortgage loan companies), contractual institutions (e.g., insurance companies and pension funds), and investment institutions (e.g., investment banks, underwriters, and brokerage firms). The levying authority system 140 may be associated with an authority (e.g., Government) imposing or collecting tax from the users. The levying authority system 140 may be connected to levying authority database 150 storing tax related information of the users such as, but not limited to, tax paid by the users in previous years, advanced tax paid by the users during current year, and carried forward taxation information of the users.

In one embodiment, the centralized taxation system 110 determines the taxation information for the time interval from the baseline data obtained from the service provider systems 130, the carried forward taxation information from the levying authority system 140 and taxation rules. The centralized taxation system 110 may include request inbound queue module 160, data aggregator 170, taxation information determiner 180, and taxation information populator 190. The request inbound queue module 160 receives requests from the users for obtaining the taxation information and stores the requests in a queue. The data aggregator 170 retrieves requests from the queue and aggregates baseline data (e.g., financial related data or investment information) from the service provider systems 130 associated with the time interval and the carried forward taxation information from the levying authority system 140. For example, the data aggregator 170 aggregates financial summary of the users as provided by the service provider systems 130 and the levying authority system 140.

In one embodiment, the taxation information determiner 180 evaluates the data obtained by the data aggregator 170 to determine the taxation information based on the obtained baseline data, carried forward taxation information and the corresponding taxation rules in real-time. For example, each jurisdiction (e.g., country) may have distinct taxation laws and rules to determine the taxation information. The taxation information determiner 180 determines the taxation information based on such distinct taxation laws and rules. Further, the taxation information and/or investment information are often populated in different taxation forms based on the type of baseline data for records and evaluation. For example, the users having certain income may have to populate a specific form and the users having income lower than certain amount may have to populate another form. Also, appropriate forms may have to be generated based on type of users (e.g., individual, company, salary, or business). In one embodiment, the taxation information populator 190 automatically determines appropriate type of taxation form to be populated based on the taxation information, the distinct laws, and the taxation rules.

In one embodiment, the populated taxation form is provided to the user system 120 from the centralized taxation system 110 so that the user may evaluate the automatically generated taxation information. For example, the populated taxation form is provided using a monitor widget displayed on a display device of the user system 120. The centralized taxation system 110 provides a method of obtaining taxation information through automation and eliminates manual accounting and paperwork. With the automatic centralized taxation system 110, manual approach of providing taxation information by the users may be avoided, so that there may not be inappropriate filings. On the other side, the automatic centralized taxation system 110 may replace a tedious process followed by the levying authority to review the taxation information provided by the users to identify cases of money laundering, tax evasion and the like.

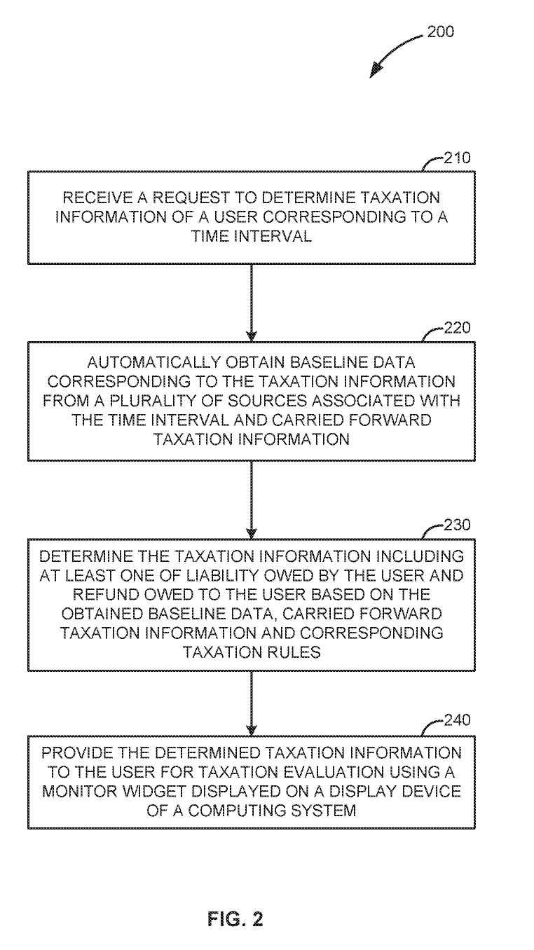

FIG. 2 is a flow diagram illustrating example process 200 to provide centralized taxation evaluation, according to an embodiment. The process 200 may include one or more functions or routines in the form of non-transitory computer-executable instructions that are stored in a tangible computer-readable storage medium and executed using a processor of a computing device. At 210, a request is received to retrieve taxation information of a user corresponding to a time interval. At a centralized taxation system, requests from users to obtain the taxation information or financial statement for the time interval (e.g., current year, three months, six months and the like) are received via a web interface application owned by a levying authority (e.g., Government). Further, the received requests may be stored in a database for further processing. For example, the request may be placed using a communication protocol such as an open data protocol (OData). OData is referred as an open protocol which allows the creation and consumption of queryable and interoperable representational state transfer (RESTful) application programming interface (API). An example request may be as shown in Table 1, where the user provides a unique identifier such as “AEVPD9878Y” as provided by the levying authority, the time interval (e.g., current financial year) for which the taxation information to be retrieved as “2017” and other personal information (e.g., email ID and contact number). Further, upon receiving the request, the centralized taxation system may provide an acknowledgement of the request as shown in Table 2, where a request ID “100020003000040005000123” is provided to the user.

TABLE 1

<REQUEST>

<TAXID>AEVPD9878Y</TAXID>
<YEAR>2017</YEAR>
<EMAIL>sdwerf@yahoo.com</EMAIL>
<PHONE>9989888989</PHONE>

</REQUEST>

TABLE 2
<REQUEST_RESPONSE>

<REQUEST_ID>100020003000040005000123</REQUEST_ID>
<TAXID>AEVPD9878Y</TAXID>

</REQUEST_RESPONSE>

At 220, baseline data corresponding to the taxation information from multiple sources associated with the time interval and carried forward taxation information are obtained automatically. The baseline data may include financial summary or investment information or account details of the user associated with the time interval. The sources may include different service providers such as financial institutes. Further, the carried forward taxation information may include an amount from the previous financial year to be considered for determining the taxation information for the time interval.

In one embodiment, a data aggregator of the centralized taxation system asynchronously processes the requests to obtain corresponding baseline data. For example, upon receiving the request, the data aggregator communicates with multiple sources such as service providers (e.g., financial institutes) to obtain the relevant data via OData service. An example request for obtaining the baseline data is shown in Table 3. The example request may include financial request details and user details.

TABLE 3
<REQUEST>

<FIN_REQ_ID>12340000000012341111</FIN_REQ_ID>
<CALLTYPE>DATA_FETCH</CALLTYPE>
<USER_DATA>

```
<USER_REQ_ID>100020003000040005000123</USER_REQ_ID>
  <TAX_ID>AEVPD9878Y</TAX_ID>
  <YEAR>2017</YEAR>
  <CURRENCY>INR</CURRENCY>
```

</USER_DATA>

</REQUEST>

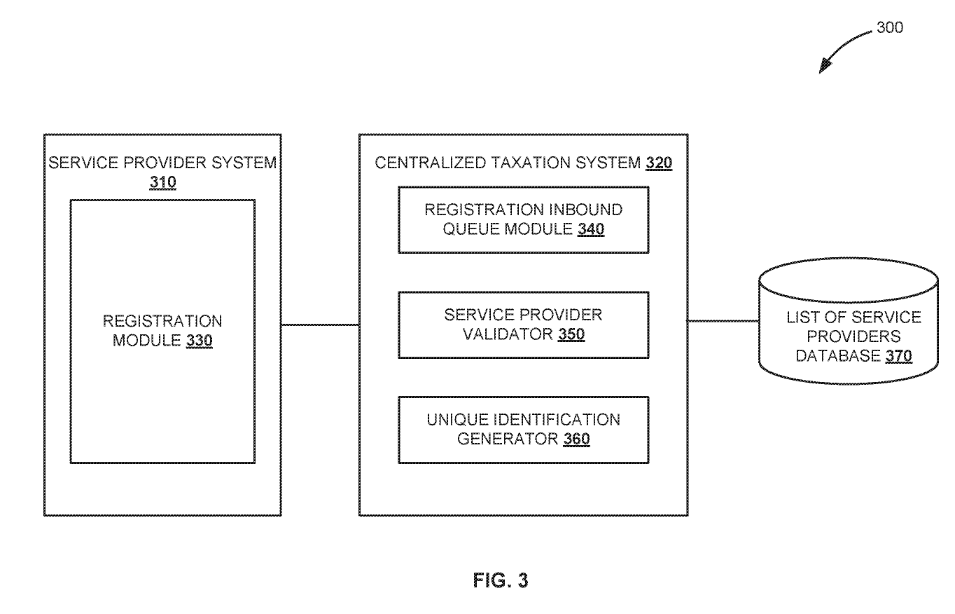

Upon receiving the request (e.g., as shown in Table 3), corresponding service provider provides or responds with the relevant baseline data. In one embodiment, the centralized taxation system authenticates the service providers providing the baseline data. For example, to authenticate the service provider, a token may be provided to the service provider during registration process. The registration process is described in greater detail in FIG. 3. Every call to the centralized taxation system may include cross-site request forgery (CSRF) token as one of the request parameters and the token may be generated when the response is from an authorized or registered service provider.

In one embodiment, the baseline data may be split into smaller datasets when the service provider may have to send a large data set as the baseline data. For each smaller subset, a checksum function may be added and a reference to the next and previous subset may be included. Hence, errors during transmission and storage may be identified. An example response including the baseline data from the service provider is shown in Table 4.

TABLE 4
<REQUEST_DATA>

<FIN_REQ_ID>12340000000012341111</FIN_REQ_ID>
<USER_REQ_ID>100020003000040005000123</USER_REQ_ID>
<TAXID>AEVPD9878Y</TAXID>
<YEAR>2017</YEAR>

</REQUEST_DATA>
<RETURN_CODE>0</RETURN_CODE>
<TRANSACTIONS>

```
<TRANSACTION>
  <ID>ABC0000123</ID>
  <AMOUNT>5489</AMOUNT>
```

<TYPE>LTCG</TYPE>
<IT_SCHEDULE>CG</IT_SCHEDULE>
<IT_ITEM>A.5</IT_ITEM>
<IT_SECTION>115AD</IT_SECTION>
<TDS>543</TDS>

</TRANSACTION>
<TRANSACTION>

<ID>ABC0000124</ID>

<AMOUNT>Q999</AMOUNT>

<TYPE>SB_INT</TYPE>
<IT_SCHEDULE>OS, VT-A</IT_SCHEDULE>
<IT_ITEM>1.B, R</IT_ITEM>
<IT_SECTION>132F, 80TTA</IT_SECTION>
<TDS>0</TDS>

</TRANSACTION>

...
</TRANSACTIONS>

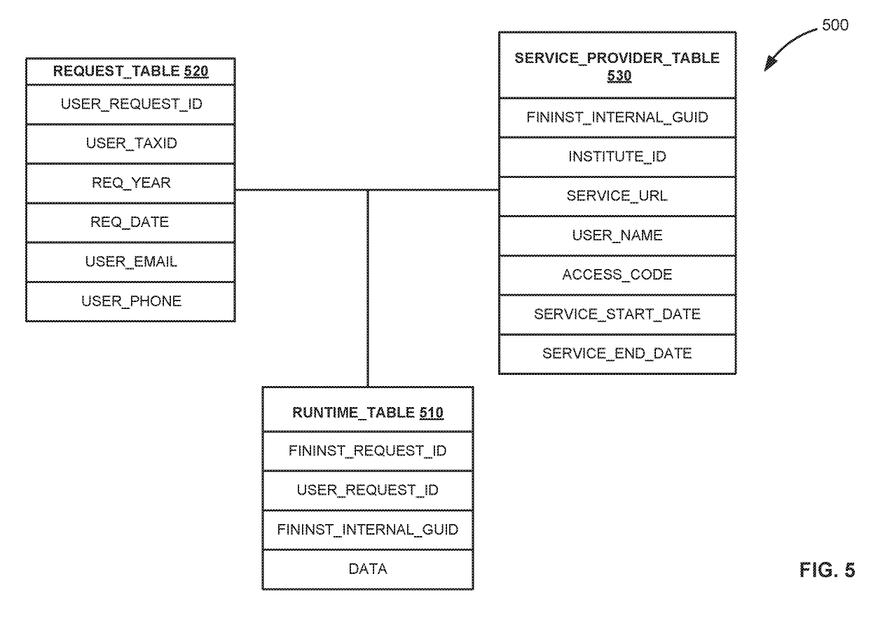

Further, the obtained baseline data may be stored in a runtime database along with the request ID. An example runtime database is described in FIG. 5. In one embodiment, the runtime database may be monitored at predefined schedules to check whether the baseline data obtained from the service providers is complete. For example, the service provider may not be ready with the baseline data corresponding to the user and may require time to compile the baseline data. In such a scenario, automatic request or reminder may be made to the service provider to provide the relevant baseline data at the earliest by checking the runtime database at regular intervals. Hence, the centralized taxation system automatically obtains the baseline data from the service providers by looping the service providers to place the request for the baseline data and making entry in the runtime database.

In one embodiment, the data aggregator communicates with a levying authority to obtain the carried forward taxation information corresponding to the previous year and store in the runtime database. For example, the carried forward taxation information may include carry forward profit and/or loss for offsetting purpose, previous tax information, tax deducted at source (TDS) information, payment information, physical address, mobile number, email ID, and like from earlier years. Thereby, the data aggregator may retrieve data from previous years' financial data to build information on top of data obtained from the service providers.

At 230, the taxation information including liability owed by the user and/or refund owed to the user are determined based on the obtained baseline data, carried forward taxation information, and corresponding taxation rules. In one embodiment, a taxation information determiner of the centralized taxation system analyzes the data obtained by the data aggregator to determine the taxation information based on the obtained baseline data, carried forward taxation information and the corresponding taxation rules. Also, pending tax may be calculated from the carried forward taxation information (e.g., TDS). For example, each jurisdiction may have distinct taxation laws and rules to determine the taxation information. The taxation information determiner determines the taxation information based on such distinct taxation laws and rules.

In one embodiment, determining the taxation information includes determining an appropriate taxation form to populate the taxation information of the user based on the baseline data, carried forward taxation information and the taxation rules. For example, the taxation information is entered in the appropriate taxation form (e.g., as financial statement or tax return document) and some entries may have to be entered in multiple sections of the taxation form as per the taxation rules. For example, interest from savings bank account is eligible for tax deductions and may be entered under ‘income from interest’ as well as under ‘other sources.’

At 240, the determined taxation information is provided to the user for taxation evaluation using a monitor widget displayed on a display device of a computing system. For example, once the taxation information is compiled, a draft tax return may be generated in a format (e.g., an excel format or other format) and then the link to download the file may be sent to the user. Further, the draft sent to the user may be downloaded, reviewed, and then may be filed with the levying authority. Also, the taxation information may be automatically extended to generate a draft tax return document based on taxation rules of a jurisdiction. Furthermore, taxation information from the runtime database may be moved to the archive database for future reference.

FIG. 3 is a block diagram of example computing environment 300 illustrating registration of service provider system 310 with centralized taxation system 320, according to one embodiment. As describes in step 220 of FIG. 2, upon receiving a request from a user to determine taxation information, the centralized taxation system 320 communicates with different service providers to obtain relevant data. As a prerequisite for the step, the service providers (e.g., the service provider system 310) may have to be registered with the centralized taxation system 320.

In one embodiment, the service provider system 310 may include registration module 330 to send a request for registration to the centralized taxation system 320. For example, the service provider system 310 (e.g., financial institute) requests for registration by submitting information such as, but not limited to unique identifier (ID) provided by a levying authority, contact information, uniform resource locator (URL) of callback service (e.g., OData service), access code and return call (e.g., OData service). Example requests from the service provider system 310 are as shown in Tables 5 and 6.

TABLE 5
<REGISTRATION_REQUEST>

<INST_ID>ABCDEFGHIJKLMNOP</INST_ID>
<NAME>ABCHoldings</NAME>
<TAXNUM>BLR0234KLJ989</TAXNUM>

<INBOUNDSERVICE_URL>https://abcholdings.com:8083/inbound/call</INBOUNDSERVICE
_URL>

<USER>98wer9879wer8f0cvsdf09</USER>
<ACCESSCODE>sfdkjfd908sf*\hat{ }$JH</ACCESSCODE>

<CONFIRMATION_URL>https://abcholdings.com:8083/confirmationcall</CONFIRMATION_{—}
URL>

....

</REGISTRATION_REQUEST>

TABLE 6

<REGISTRATION_REQUEST>

<INST_ID>ABCDEFGHIJKLMNOP</INST_ID>
<FIN_REQ_ID>12340000000012340000</FIN_REQ_ID>

</REGISTRATION_REQUEST>

In one embodiment, the centralized taxation system 320 may include registration inbound queue module 340, service provider validator 350 and unique identification generator 360 to process the request received from the service provider system 310. The inbound queue module 340 receives the request from the service provider system 310. Further, the request may be stored in a database for further processing when multiple requests are received from different service providers. In one embodiment, the request to register with the centralized taxation system 320 may be initialized by the centralized taxation system 320.

In one embodiment, the service provider validator 350 validates the service provider by analyzing the request. For example, validation may be performed by verifying requested entries, and checking against known and registered financial institutes with a levying authority (e.g., Government). Further, synchronous access to callback URL with access code may be made. Examples for synchronous access for verification may be as shown in Tables 7 and 8. The request may include return code for verification. Further, results or responses of validations may be informed to the service provider system 310 and then stored in a database. Also, when authentication failure of the service provider system 310 causes a rejection in verification, notice may be sent back to the service provider system 310.

TABLE 7

<REQUEST>

<FIN_REQ_ID>12340000000012340000</FIN_REQ_ID>
<CALLTYPE>CALL_VERI</CALLTYPE>

</REQUEST>

TABLE 8

<FIN_REQ_ID>12340000000012340000</FIN_REQ_ID>
<RETURN_CODE>0</RETURN_CODE>
<FININST_DETAILS>

<INST_ID>ABCDEFGHIJKLMNOP</INST_ID>
<NAME>ABCHoldings</NAME>
<TAXNUM>BLR0234KLJ989</TAXNUM>
....

</FININST_DETAILS>

In one embodiment, unique identification generator 360 may generate unique ID, and access code for successful requesters or validated service provider systems. Also, successful and verified details may be stored in a database (e.g., list of service providers database 370) for future usage. Hence, the list of service providers database 370 may include a final list of verified service providers or onboarded service providers. Further, the service provider system 310 may be informed by sending approval with generated unique ID (e.g., FIN_INTERNAL_GUID), inbound URL (e.g., SERVICE) and access code. Example confirmation message is shown in Table 9. Also, confirmation data to the service provider system 310 may be sent over secure channels, using network packets and handshake protocol, for example. In one embodiment, access to the service providers may be allotted for a pre-defined duration (e.g., 5 years).

TABLE 9
<CONFIRMATION>

<FIN_REQ_ID>12340000000012340000</FIN_REQ_ID>
<INST_ID>ABCDEFGHIJKLMNOP</INST_ID>
<FIN_INTERNAL_GUID>ABC_23424324_4320582034824</FIN_INTERNAL_GUID>
<SERVICE_URL>https://taxation.sap.com:8444/input/rolling</SERVICE_URL>
<USER>98wer9879wer8f0cvsdf09</USER>
<ACCESSCODE>sfdkjfd908sf*\hat{ }$JH</ACCESSCODE>

</CONFIRMATION>

Hence, the service providers may register as genuine service providers with the centralized taxation system 320 by providing their details and the URL of their OData service using which the centralized taxation system 320 would contact the service providers to obtain the baseline data. Also, the service providers may provide the user credentials which may be used for the URL, for example. Further, the centralized taxation system 320 may check the authenticity of the request. Once authenticated, a unique identifier may be generated for the service provider and then added to the list of approved service providers. Also, an acknowledgement may be sent about the acceptance and the URL may be provided to the service provider which may be used to call back to the centralized taxation system 320 with the baseline data.

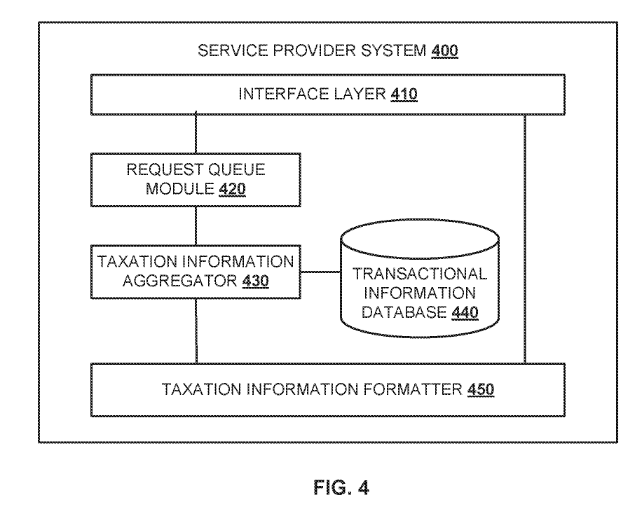

FIG. 4 is a block diagram of example service provider system 400 illustrating processing a request, according to one embodiment. Upon receiving the request to obtain the baseline data of a user, the service provider system 400 may either have a background job or a real-time job to compile the baseline data from a database, format the baseline data, and provides the formatted baseline data to a centralized taxation system.

In one embodiment, the service provider system 400 may include interface layer 410, request queue module 420, taxation information aggregator 430, transactional information database 440, and taxation information formatter 450. The interface layer 410 facilitates to communicate with the centralized taxation system during registration, receiving request for taxation information, and sending response for the request. The request queue module 420 receives the requests via the interface layer 410, and stores the requests in a queue.

In one embodiment, the taxation information aggregator 430 asynchronously processes the requests in the request queue module 420. The taxation information aggregator 430 retrieves the baseline data associated with the users from the transactional information database 440. The transactional information database 440 stores the baseline data or financial statements of users along with corresponding date. Further, the taxation information formatter 450 formats the baseline data in a format required by the centralized taxation system. An example format of the baseline data is as shown in Table 10. Also, the process described in obtaining the baseline data is one example method. Different service providers may internally compile the baseline data in their landscape in different ways.

TABLE 10
<REQUEST>

<ID>WER908WE098WER908W0R9WR</ID>
<PAN_NUMBER>AEVPD5988P</ PAN_NUMBER>
<AADHAR>678987654567</AADHAR>
<ASSYEAR>2017-2018</ASSYEAR>
<CURRENCY>INR</CURRENCY>

</REQUEST>
<FINANCIALINSTITUTE>
<TRANSACTIONS>

<TRANSACTION>

```
<ID>HSCC90098000</ID>
<AMOUNTPAID>40000</AMOUNTPAID >
  <TYPEOFPAYMENT>SBINT</ TYPEOFPAYMENT >
  <TDS>5000</TDS >
```

```
  </TRANSACTION>
  <TRANSACTION>
```

```
<ID>HSCC90098001</ID>
<AMOUNTPAID>1000</AMOUNTPAID >
  <TYPEOFPAYMENT>LTCG</ TYPEOFPAYMENT >
  <TDS>0</TDS >
```

</TRANSACTION>
<TRANSACTION>

```
<ID>HSCC90098002</ID>
<AMOUNTPAID>500</AMOUNTPAID >
  <TYPEOFPAYMENT>STCG</ TYPEOFPAYMENT >
  <TDS>40</TDS >
```

</TRANSACTION>

</TRANSACTIONS>

For example, another format of the baseline data using POST call of REST API is shown in Table 11.

TABLE 11

<T:TRANSACTIONS xmlns: T=”urn:ietf:params:xml:ns:taxdav”>

BEGINS: TRANSACTIONS
REQID: −12340000000000000000001234111111
USERID: 100200030000400050000123
TAXID: AEVPD9878Y
YEAR: 2017
BEGIN: TRANSACTION

ID: ABC0000123
AMOUNT: 5489
TYPE: LTCG
IT_SCHEDULE: CG
IT_ITEM: A.5
IT_SECTION: 115AD
TDS: 543

END: TRANSACTION
BEGIN: TRANSACTION

ID: ABC00000124
AMOUNT: Q999
TYPE: SB_INT
IT_SCHEDULE: OS, VI-A
IT_ITEM: 1.B, R
IT_SECTION: 132f, 80TTA
TDS: 0

END: TRANSACTION

END: TRANSACTIONS

FIG. 5 shows example runtime database 500, according to one embodiment. The runtime database 500 may include runtime table 510, which further connected to request table 520 and service provider table 530 to store requests for taxation information and corresponding baseline data. The requests as received from the users for determining taxation information may be stored in the request table 520. The request table 520 may include, but not limited to, request identifier, user identifier, time interval for which taxation information is desired, and user contact details (e.g., user email ID and contact number).

Upon receiving a request to determine the taxation information, a valid list of service providers may be retrieved from the service provider table 530. Further, service provider URL and levying authority URL may be called to obtain baseline data. After receiving the baseline data from the service providers, a check is made to validate return code and determine whether FININST_REQUEST_ID and USER_REQUEST_ID from runtime table 510 matches with data in the request. Upon verification, a check is made to determine whether USER_REQUEST_ID, USER_TAXID and REQ_YEAR from the request table 520 are same. When the details are matched, the response or baseline data as received from service providers may be stored in the service provider table 530. The service provider table 530 may include, but not limited to, service provider identifier, service URL, access code and time interval (e.g., start date and end date) for which the taxation information is determined. Further, the runtime table 510 includes an index for the request table 520 and the service provider table 530. Further, when an error is identified, the service providers may be informed accordingly. Also, the request table 520 and the runtime table 510 may be cleared (e.g., data is deleted) after a predefined expiration period (e.g., retention period), and an archive table may be updated.

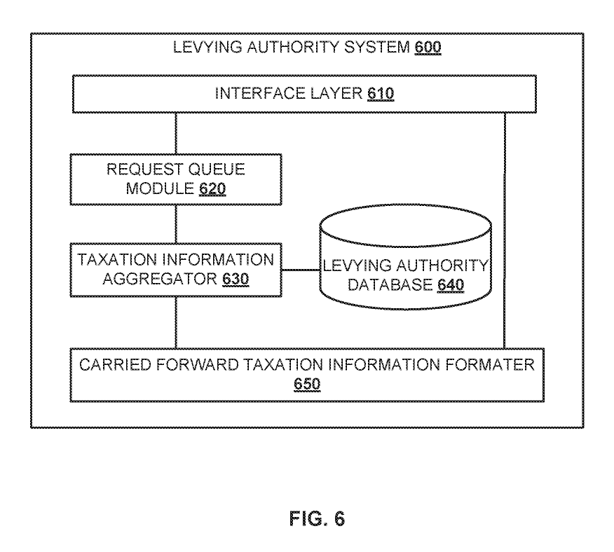

FIG. 6 is a block diagram of example levying authority system 600 illustrating processing of a request, according to one embodiment. Upon receiving the request to obtain carried forward taxation information of a user, the levying authority system 400 may either have a background job or a real-time job to compile the carried forward taxation information from a database, formats the carried forward taxation information, and provides the formatted carried forward taxation information to a centralized taxation system.

In one embodiment, the levying authority system 600 may include interface layer 610, request queue module 620, taxation information aggregator 630, levying authority database 640, and carried forward taxation information formatter 650. The interface layer 610 facilitates to communicate with the centralized taxation system while receiving the request for the carried forward taxation information and sending response for the request. The request queue module 620 receives the requests via the interface layer 610 and store the requests in a queue.

In one embodiment, the taxation information aggregator 630 asynchronously processes the requests in the request queue module 620. The taxation information aggregator 630 retrieves the carried forward taxation information associated with the users from the levying authority database 640. The levying authority database 640 stores the taxation information or financial statements of users of previous years. Further, the carried forward taxation information formatter 650 formats the carried forward taxation information in a format required by the centralized taxation system.

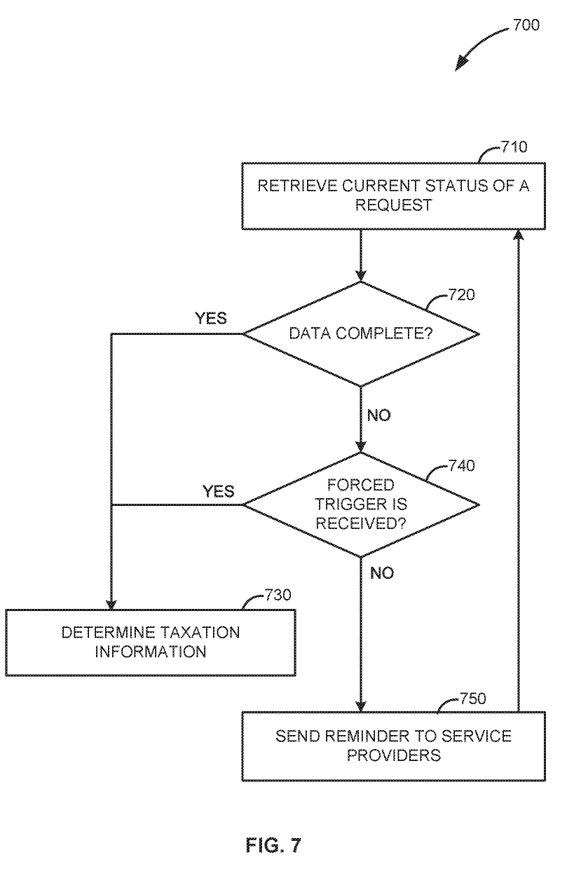

FIG. 7 is a flow diagram illustrating example process 700 to provide taxation information when baseline data is incomplete, according to an embodiment. At 710, current status of a request for obtaining the taxation information is retrieved. Users may check the status of the request from time to time via a web interface application. The web interface application controlled by a levying authority may provide the current status, and a list of service providers indicating which service providers have provided the baseline data and which ones have not. For example, from the web interface application, user can invoke OData service to check the status information.

At 720, a check is made to determine whether the obtained baseline data is complete or not. When the obtained baseline data is complete, the taxation information may be determined as described in FIG. 2, as in 730. When the obtained baseline data is incomplete, a check is made to determine whether a forced trigger is received from the user, as in 740. For example, when the user feels confident that the data gathered is sufficient for the user to file tax returns or when the user desires to evaluate the taxation information with the obtained baseline data, the user may trigger to determine the taxation information with the steps described in FIG. 2. At 750, when the user does not provide forced trigger, then a reminder may be sent to the service providers to provide the baseline data.

In one embodiment, the service providers may have to adhere to a predefined service level agreement (SLA) on how much time the service provider may take to send the baseline data. Also, the request to obtain the baseline data may be escalated when the service provider takes long time compared to the SLA. For example, when a job is executed to compile the baseline data, a centralized taxation system may figure out when the SLA has been exceeded. In such cases, a trigger may be sent to the service provider via OData service. Based on the escalation flag, the service provider may delegate the call to a real-time job and ensure that a result is provided at the earliest. Any deviations may lead to penalizing the service providers.

With the centralized taxation system, tax avoidance due to lack of knowledge and hassle in collecting relevant information may not be a concern for the users and the levying authority. The number of people who file tax returns may increase since determining the taxation information is automated. Further, the accuracy of the tax filings may be improved.

Some embodiments may include the above-described methods being written as one or more software components. These components, and the functionality associated with them, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” includes a single medium or multiple media that stores one or more sets of instructions. The term “computer readable storage medium” includes physical article that is capable of undergoing a set of physical changes to physically store, encode, or otherwise carry a set of instructions for execution by a computer system which causes the computer system to perform the methods or process steps described, represented, or illustrated herein. A computer readable storage medium may be a non-transitory computer readable storage medium. Examples of a non-transitory computer readable storage media include, but are not limited to: magnetic media, such as hard disks, floppy disks, and magnetic tape, optical media such as CD-ROMs, DVDs and holographic indicator devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment may be implemented using Java, C-++, or other object-oriented programming language and development tools. Another embodiment may be implemented in hard-wired circuitry in place of, or in combination with machine readable software instructions.

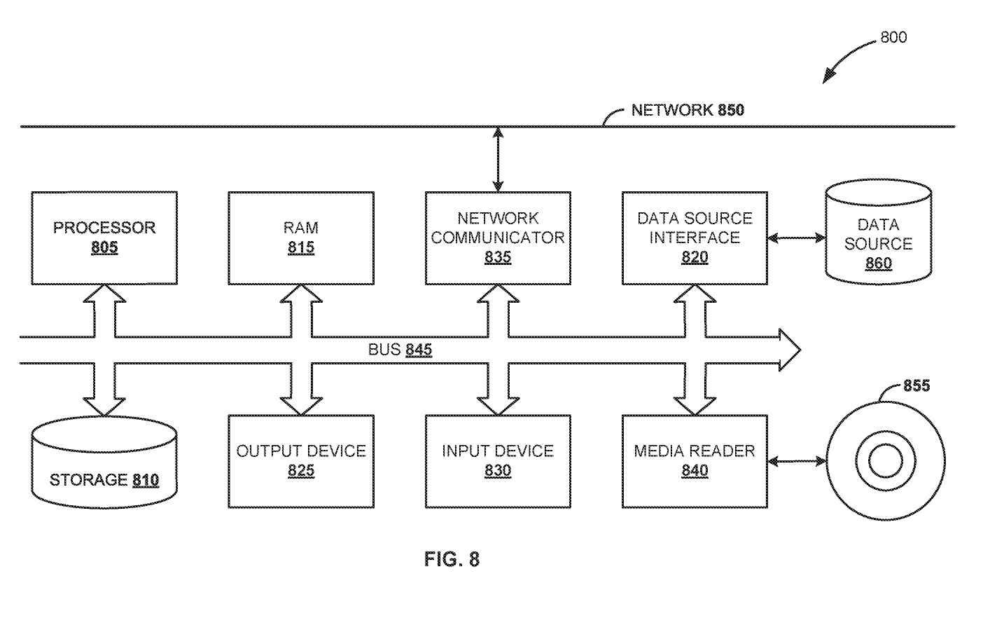

FIG. 8 is a block diagram of example computer system 800, according to an embodiment. The computer system 800 includes a processor 805 that executes software instructions or code stored on a computer readable storage medium 855 to perform the above-illustrated methods. The processor 805 can include a plurality of cores. The computer system 800 includes a media reader 840 to read the instructions from the computer readable storage medium 855 and store the instructions in storage 810 or in random access memory (RAM) 815. The storage 810 provides a large space for keeping static data where at least some instructions could be stored for later execution. According to some embodiments, such as some in-memory computing system embodiments, the RAM 815 can have sufficient storage capacity to store much of the data required for processing in the RAM 815 instead of in the storage 810. In some embodiments, the data required for processing may be stored in the RAM 815. The stored instructions may be further compiled to generate other representations of the instructions and dynamically stored in the RAM 815. The processor 805 reads instructions from the RAM 815 and performs actions as instructed. According to one embodiment, the computer system 800 further includes an output device 825 (e.g., a display) to provide at least some of the results of the execution as output including, but not limited to, visual information to users and an input device 830 to provide a user or another device with means for entering data and/or otherwise interact with the computer system 800. One or more of these output devices 825 and input devices 830 could be joined by one or more additional peripherals to further expand the capabilities of the computer system 800. A network communicator 835 may be provided to connect the computer system 800 to a network 850 and in turn to other devices connected to the network 850 including other clients, servers, data stores, and interfaces, for instance. The modules of the computer system 800 are interconnected via a bus 845. Computer system 800 includes a data source interface 820 to access data source 860. The data source 860 can be accessed via one or more abstraction layers implemented in hardware or software. For example, the data source 860 may be accessed by network 850. In some embodiments, the data source 860 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open Database Connectivity (ODBC), produced by an underlying software system, e.g., an enterprise resource planning (ERP) system, and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments. One skilled in the relevant art will recognize, however that the one or more embodiments can be practiced without one or more of the specific details or with other methods, components, techniques, etc. In other instances, well-known operations or structures are not shown or described in details.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments of, and examples for, the embodiment are described herein for illustrative purposes, various equivalent modifications are possible within the scope of the embodiments, as those skilled in the relevant art will recognize. These modifications can be made to the embodiments in light of the above detailed description. Rather, the scope of the one or more embodiments is to be determined by the following claims, which are to be interpreted in accordance with established doctrines of claim construction.

What is claimed is:

1. A computer-implemented method to provide a centralized taxation evaluation, comprising:
receiving, at a request inbound queue module of a centralized taxation system, a request to determine taxation information of a user corresponding to a time interval;
automatically obtaining baseline data corresponding to the taxation information from a plurality of sources associated with the time interval and carried forward taxation information by a data aggregator of the centralized taxation system;
determining the taxation information including at least one of liability owed by the user and refund owed to the user based on the obtained baseline data, carried forward taxation information and corresponding taxation rules by a taxation information determiner of the centralized taxation system; and
providing the determined taxation information to the user for taxation evaluation using a monitor widget displayed on a display device of a computing system.

2. The computer-implemented method of claim 1, wherein determining the taxation information further comprises determining an appropriate taxation form to populate the taxation information of the user based on the baseline data, carried forward taxation information, and the taxation rules.

3. The computer-implemented method of claim 1, wherein the plurality of sources comprises a plurality of service provider systems, and wherein the plurality of service provider systems comprises registration modules to register with the centralized taxation system.

4. The computer-implemented method of claim 1, wherein the baseline data comprises financial statements of the user associated with the plurality of sources within the time interval.

5. The computer-implemented method of claim 1, wherein the carried forward taxation information is obtained from a levying authority system, and wherein the carried forward taxation information comprises carry forward profit or loss associated with taxation information of a previous year.

6. The computer-implemented method of claim 1, wherein the taxation rules are associated with taxation laws of a jurisdiction.

7. The computer-implemented method of claim 1, further comprising receiving forced trigger to determine the taxation information when the received baseline data is incomplete; and determining the taxation information with the incomplete baseline data.

8. A computing system to provide centralized taxation evaluation, comprising:
at least one processor; and
one or more memory devices communicative with the at least one processor, wherein the one or more memory devices store instructions to:
provide a web interface application to provide taxation information from a centralized taxation system, wherein the centralized taxation system comprises:
a request inbound queue module to receive a request to determine the taxation information of a user corresponding to a time interval;
a data aggregator to automatically obtain baseline data corresponding to the taxation information from a plurality of sources associated with the time interval and carried forward taxation information; and
a taxation information determiner to determine the taxation information including at least one of liability owed by the user and refund owed to the user based on the obtained baseline data, carried forward taxation information and corresponding taxation rules.

9. The computing system of claim 8, wherein the plurality of sources comprises a plurality of service provider systems and wherein the plurality of service provider systems comprises registration modules to register with the centralized taxation system.

10. The computing system of claim 8, wherein the centralized taxation system further comprises:
a registration inbound queue module to receive a request from a service provider system for registration;
a service provider validator to validate the service provider by analyzing the request; and
an unique identification generator to generate unique ID, and access code for the validated service provider system.

11. The computing system of claim 8, wherein the carried forward taxation information is obtained from a levying authority system, and wherein the carried forward taxation information comprises carry forward profit or loss associated with taxation information of a previous year.

12. The computing system of claim 8, wherein the taxation rules are associated with taxation laws of a jurisdiction.

13. The computing system of claim 8, wherein the centralized taxation system further comprises a taxation information populator to determine an appropriate taxation form to populate the taxation information of the user based on the baseline data, carried forward taxation information, and the taxation rules.

14. The computing system of claim 8, wherein the baseline data comprises financial statements of the user associated with the plurality of sources within the time interval.

15. A non-transitory computer readable storage medium storing instructions, which when executed by a computer cause the computer to:
receive a request to determine taxation information of a user corresponding to a time interval;
automatically obtain baseline data corresponding to the taxation information from a plurality of sources associated with the time interval and carried forward taxation information;
determine the taxation information including at least one of liability owed by the user and refund owed to the user based on the obtained baseline data, carried forward taxation information and corresponding taxation rules;
determine an appropriate taxation form to populate the taxation information of the user based on the baseline data, carried forward taxation information, and the taxation rules; and
provide the determined appropriate taxation form to the user for taxation evaluation using a monitor widget displayed on a display device of a computing system.

16. The non-transitory computer-readable medium of claim 15, wherein the plurality of sources comprises a plurality of service provider systems, and wherein the plurality of service provider systems comprises registration modules to register with the centralized taxation system.

17. The non-transitory computer-readable medium of claim 15, wherein the carried forward taxation information is obtained from a levying authority system, and wherein the carried forward taxation information comprises carry forward profit or loss associated with taxation information of a previous year.

18. The non-transitory computer-readable medium of claim 15, wherein the taxation rules are associated with taxation laws of a jurisdiction.

19. The non-transitory computer-readable medium of claim 15, wherein the baseline data comprises financial statements of the user associated with the plurality of sources within the time interval.

20. The non-transitory computer-readable medium of claim 15, further comprising instructions to receive forced trigger to determine the taxation information when the received baseline data is incomplete; and determine the taxation information with the incomplete baseline data.
